(19) United States
(12) Patent Application Publication
(10) Pub. No.: US 2024/0360288 A1
(43) Pub. Date: Oct. 31, 2024

(54) PLANT SOURCED INSULATION FOAM

(71) Applicant: UT-Battelle, LLC, Oak Ridge, TN (US)

(72) Inventors: Diana Hun, Oak Ridge, TN (US); Tomonori Saito, Oak Ridge, TN (US); Zoriana Demchuk, Oak Ridge, TN (US); Som S. Shrestha, Oak Ridge, TN (US); Karen P. Cortes Guzman, Oak Ridge, TN (US)

(21) Appl. No.: 18/646,199

(22) Filed: Apr. 25, 2024

Related U.S. Application Data
(60) Provisional application No. 63/461,646, filed on Apr. 25, 2023.

(51) Int. Cl. C08J 9/06; C08J 9/12

(52) U.S. Cl. CPC C08J 9/06; C08J 9/12; C08J 2203/184; C08J 2391/00; C08J 2479/02

(57) ABSTRACT

A low-carbon, recyclable, plant-based foam insulation composition is provided. The composition includes an acrylate-functionalized plant-based organic resin. The composition further includes an amino-functionalized crosslinker. The composition also includes a chemical blowing agent. A method of manufacturing the low-carbon, recyclable, plant-based foam insulation composition is further provided. A method for preparing a low-carbon, recyclable, plant-sourced insulation foam is provided. The method comprises the step of combining an acrylate-functionalized plant-sourced organic polymer and a chemical blowing agent to give a biobased acrylate functionalized precursor. The biobased acrylate precursor and an amino-functionalized crosslinker are combined to give an uncured foam insulation composition. The uncured foam insulation composition is allowed to cure to give the plant-sourced insulation foam.

### CROSS-REFERENCE TO RELATED APPLICATIONS

This application claims the benefit of U.S. Provisional Application 63/461,646, filed Apr. 25, 2023, the disclosure of which is hereby incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a foam insulation composition and associated methods of manufacture.

### BACKGROUND OF THE INVENTION

Polymer-based foams, either spray-applied or manufactured as boards, comprise about one-third of the North American thermal insulation market. Foam boards are superior to fibrous boards because they allow for easier handling and have high compression loads. Spay-applied foams are used as integral parts of air barrier systems to seal crevices between building envelope components. Conventional polymeric foams are primarily petroleum-based because of the low cost and established production methods associated with petroleum-based polymeric foams. Inherent in petroleum-based polymeric foams is the necessity for raw materials and production processes that require large amounts of non-renewable petroleum and energy, as well as blowing agents with high global warming potentials. Petroleum-based foams have higher embodied energy than other building insulation materials. Some petroleum-based foams also have issues with toxicity. For example, polyisocyanurate (PIR) and polyurethane (PU) foams generally require isocyanate as a polymer intermediate, which poses toxicity issues and requires high-temperature processing that also increases the embodied energy of the polymeric foams.

Plant-based polymers, derived from renewable biomass sources such as starches, cellulose, and proteins, have garnered attention due to their biodegradability, abundance, and low environmental impact. These polymers can be tailored to possess desirable properties, making them suitable for a wide range of applications, including packaging, agricultural films, and disposable products. Plant-based polymers have been widely used in paints, coatings, composites, lacquers, and other similar products. The use of biobased polymers can dramatically decrease the embodied carbon in select products because plants sequester about 1.83 kg of CO₂ per 1 kg of biomass growth. The carbon sequestration effect is further magnified when biopolymers can be recycled with a minimum amount of processing energy.

### SUMMARY OF THE INVENTION

A low-carbon, recyclable, plant-based foam insulation composition is provided. The composition comprises (A) an acrylate-functionalized plant-based organic resin; (B) an amino-functional crosslinker; and (C) a chemical blowing agent. The acrylate-functionalized plant-based organic resin may comprise, alternatively may be, pentaerythritol tetraacrylate (PETA), acrylated linseed oil, acrylated cardanol, and similar compounds. The acrylate-functionalized plant-based organic resin is an acrylate-functionalized vegetable oil. The acrylate-functionalized vegetable oil is an acrylated epoxidized soybean oil (AESO). The acrylate-functionalized plant-based organic resin and the amino-functionalized crosslinker are present in the composition in a molar ratio of about 2:1, 1.75:1, and 1.5:1. The composition demonstrates excellent recyclability, and preserves excellent tensile strength and strain resistance even after three recycling cycles.

The amino-functionalized crosslinker is any of di, tri, and tetra amines selected from one of: (i) aliphatic amines; (ii) polyether amines; or (iii) aromatic amines. The amino functional crosslinker may be selected from one of: (i) diaminobutane; (ii) polyether diamine; or (iii) diaminopentane. The amino-functionalized crosslinker may be polyether diamine. The amino-functionalized crosslinker may be a plant-sourced amino functional crosslinker. The (C) chemical blowing agent is polymethylhydrosiloxane. The composition further comprises (D) a physical blowing agent. The chemical blowing agent and/or physical blowing agent are present in the composition in a weight loading of between 1 to 30 wt. %. from the total foam formulation. The composition further comprises (E) a surfactant. The composition further comprises (F) a flame retardant agent. The composition further comprises (G) solvent and catalyst (H).

The composition conforms to at least one of the following requirements:
(i) the acrylate functionalized plant-sourced organic resin (A) has a renewable carbon content of greater than 60%;
(ii) the amino-functionalized crosslinker (B) has a renewable carbon content from 0 to 100%;
(iii) the composition has a renewable carbon content of greater than 60%; or
(iv) any combination of (i)-(iii).

A method for preparing a low-carbon, recyclable, plant-sourced insulation foam is provided. The method comprises the step of combining an (A) acrylate functionalized plant-sourced organic resin, surfactant (E), physical blowing agent (D), (C) a chemical blowing agent, and solvent to give a biobased acrylate functionalized precursor. The biobased acrylate precursor and (B) an amino-functionalized crosslinker are combined via mixing to give an uncured foam insulation composition. The uncured foam insulation composition is allowed to cure to give the plant-sourced insulation foam.

The step of combining the acrylate-functionalized plant-sourced organic resin and the chemical blowing agent to give the biobased acrylate functionalized precursor further comprises combining the acrylate-functionalized plant-sourced organic resin and the chemical blowing agent with a physical blowing agent, a surfactant, a flame-retardant agent, and/or solvent. The chemical blowing agent and/or physical blowing agent are present in the biobased acrylate functionalized precursor in a weight loading of between 1 to 30 wt. % of the total foam mixture

The method further comprises the step of stirring the biobased acrylate functionalized precursor for between 1 and 5 minutes. Then, the amino-functionalized crosslinker is added and the foam mixture is further mixed at 1000 r.p.m. for between 1 and 60 seconds. The step of allowing the uncured foam insulation composition to cure to give the plant-sourced insulation foam further comprises foam generation that occurs within 0.5 to 20 minutes. The method further comprises the step of heating the plant-sourced insulation foam to a temperature of between 20 and 50° C.

These and other features and advantages of the present invention will become apparent from the following description of the invention when viewed in accordance with the accompanying drawings and appended claims.

### BRIEF DESCRIPTION OF THE DRAWINGS

FIG. 1 is a schematic depiction of the manufacturing process, benefits, and feedstocks for the plant-sourced foam insulation composition.

FIG. 2 is a visual depiction of how the amount of blowing agent impacts the volume of the plant-sourced foam insulation composition.

FIG. 3 is a graph of displacement vs. applied force demonstrating the compressive strength of the foam insulation composition according to several embodiments.

FIG. 4 is a graph of temperature vs. weight loss (%) demonstrating the temperature stability of the inventive composition compared to conventional insulation foams.

FIG. 5 is a graph of temperature vs. storage modulus of the foam insulation composition according to several embodiments.

The embodiments depicted in the Figures are merely exemplerary, and do not limit the invention in any way. Alternative embodiments may use alternative components not used or depicted in the Figures.

### DETAILED DESCRIPTION OF THE CURRENT EMBODIMENTS

A low-carbon, recyclable, plant-sourced foam insulation composition (“the composition”) is provided. The composition comprises (A) an acrylate functionalized plant-sourced organic resin. The composition also comprises (B) an amino-functionalized crosslinker. The composition further comprises (C) a chemical blowing agent. The composition demonstrates excellent thermal stability compared to similar insulation foams and is recyclable. The composition has a reduced carbon footprint in view of its plant-based sourcing and has a range of environmental benefits including reduced energy demand, reduced ozone depletion, and low ecotoxicity.

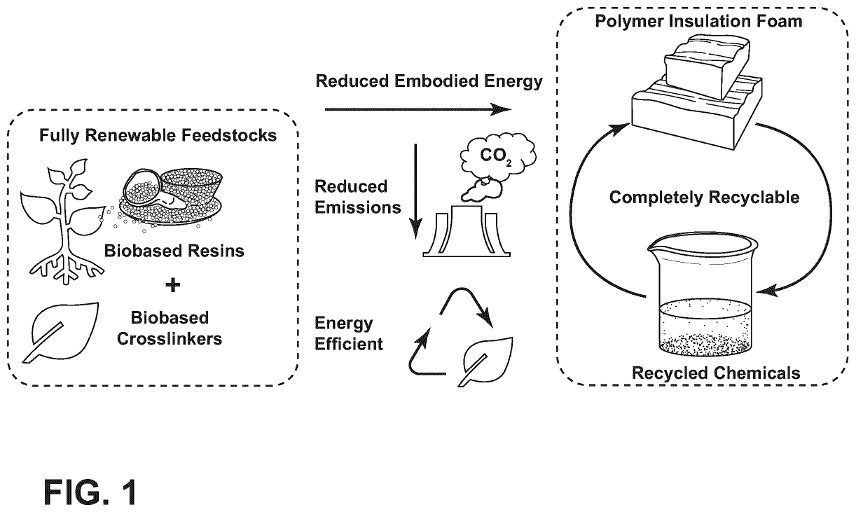

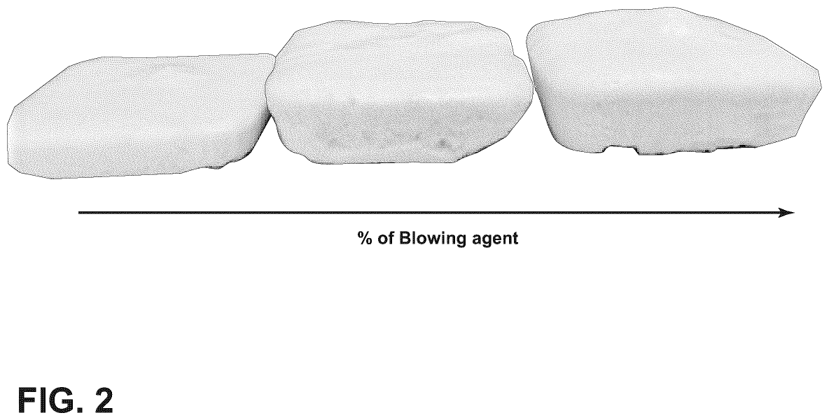

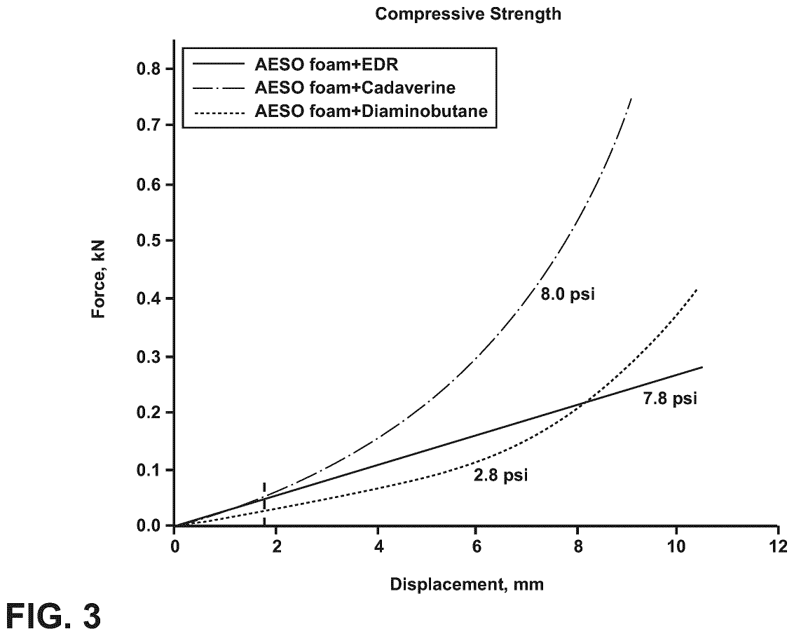

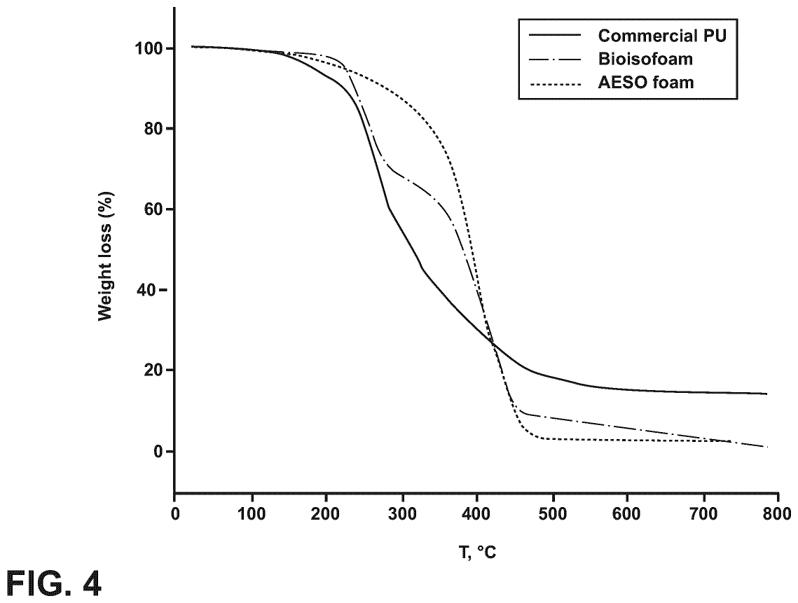

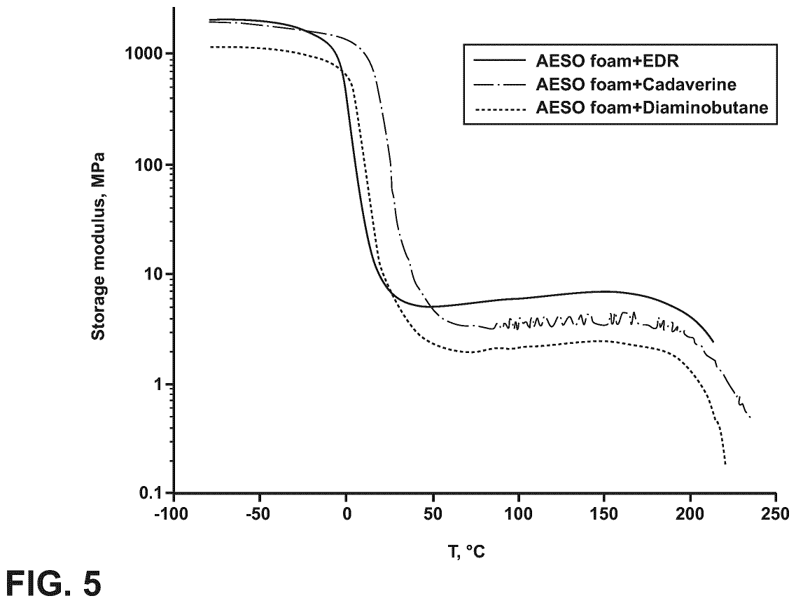

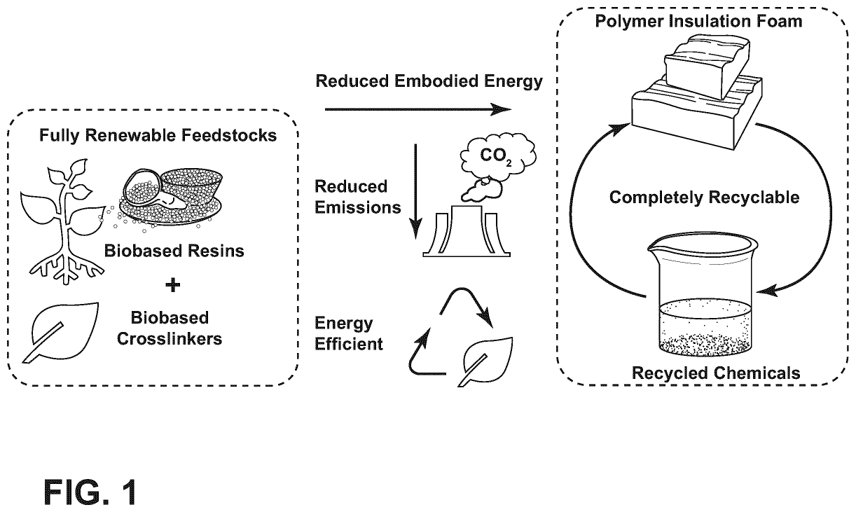

Referring now to FIG. 1, FIG. 1 shows a schematic depiction of feedstocks and method for the manufacture of the composition. The composition comprises (A) an acrylate functionalized plant-sourced organic resin. The (A) acrylate-functionalized plant-sourced organic resin is an acrylate-functionalized vegetable oil. In some embodiments, the (A) acrylate-functionalized plant-sourced organic resin has a renewable carbon content of greater than 60%, alternatively of greater than 70%, alternatively of greater than 80%. Further non-limiting examples of the (A) acrylate-functionalized plant-sourced organic resin include soybean oil acrylate, linseed oil acrylate, castor oil acrylate, palm oil acrylate, sunflower oil acrylate, rapeseed oil acrylate (canola oil), olive oil acrylate, corn oil acrylate, safflower oil acrylate, coconut oil acrylate, cottonseed oil acrylate, jojoba oil acrylate, tung oil acrylate, walnut oil acrylate, almond oil acrylate, hazelnut oil acrylate, avocado oil acrylate, hemp oil acrylate, pumpkin seed oil acrylate, sesame oil acrylate, acrylated epoxidized vegetable oil, acrylated gallic acid, vanillin diacrylate, and eugenol diacrylate.

The composition comprises (B) an amino-functionalized crosslinker. The (B) amino-functionalized crosslinker is selected from one of di, tri, and tetra amines selected from one of: (i) aliphatic amines; (ii) polyether amines; or (iii) aromatic amines. In some embodiments, the amino-functionalized crosslinker (B) has a renewable carbon content of greater than 0%, alternatively of greater than 60%, and alternatively of greater than 80%. Further non-limiting examples of the (B) amino-functionalized crosslinker include ethylenediamine (EDA), diethylenetriamine (DETA), triethylenetetramine (TETA), tetraethylenepentamine (TEPA), propylenediamine (PDA), 1,3-diaminopropane (DAP), N-methyl-1,3-propanediamine (MPDA), 1,4-diaminobutane (DAB), isophoronediamine (IPDA), N,N-dimethylethylenediamine (DMEDA), N,N-dimethylpropylenediamine (DMPDA), hexamethylenediamine (HMDA), N,N-dimethylhexamethylenediamine (DMHMDA), isophthalic diamine (IPD), 4,4′-diaminodicyclohexylmethane (H12MDA), polyethyleneimine (PEI), polyethylene glycol bisamine, ethanolamine (MEA), diethanolamine (DEA), triethanolamine (TEA), and aminoethylpiperazine (AEP). The amino-functionalized crosslinker (B) may further comprise, alternatively may be, a plant-sourced amino-functionalized crosslinker (B). The acrylate-functionalized plant-sourced organic resin (A) and amino-functionalized crosslinker (B) may be present in a molar ratio of from between 5:1 to 1:5, alternatively between 3:1 to 1:3, alternatively about 2:1, alternatively 1.75:1, 1.5:1.

The composition further comprises the (C) chemical blowing agent. The (C) chemical blowing agent is a polymethylhydrosiloxane (PMHS). The composition may comprise the chemical blowing agent (C) in an amount of between 0.1 to 20 wt. %, alternatively between 0.5 to 15 wt. %, alternatively between 1 to 10 wt. %, or alternatively between 2 to 8 wt. %. Further non-limiting examples of the (C) chemical blowing agent include azodicarbonamide (ADC), hydrochlorofluorocarbons (HCFCs) (e.g., HCFC-22, HCFC-142b), hydrofluorocarbons (HFCs) (e.g., HFC-134a, HFC-152a, HFC-245fa), esters (e.g., dimethyl carbonate, ethyl acetate, methyl formate), ammonium carbonate, sodium bicarbonate, sodium borohydride, sodium nitrite, and sodium azide.

The composition further comprises (D) a physical blowing agent. The (D) physical blowing agent may be hydrofluoroolefin (HFO) (Opteon 1100) with low global warming potential. Further non-limiting examples of the (D) physical blowing agent include other hydrofluoroolefins, carbon dioxide, nitrogen, air, hydrocarbons (e.g., pentane, isopentane, cyclopentane, n-butane, isobutane, cyclobutene, propane), chlorofluorocarbons, hydrofluorocarbons (e.g., HFC-134a, HFC-152a, HFC-245fa), and ammonia. In embodiments where the physical blowing agent (D) is present, the physical blowing agent will be different from the chemical blowing agent (C).

The composition further comprises (E) a surfactant. Some non-limiting examples of the (E) surfactant include silicone surfactants, sodium dodecyl sulfate, Triton™ surfactants, polydimethylsiloxane (PDMS), perfluorinated compounds, alkyl polyethylene glycol ethers, alkylphenol ethoxylates, sorbitan esters, alkyl sulfates, alkyl ether sulfates, sulfonates, alkylammonium salts, quaternary ammonium compounds, betaines, ethylene oxide (EO) and propylene oxide (PO) copolymers, fatty acid esters, fatty alcohol ethoxylates, and fatty amine ethoxylates.

The composition further comprises (F) a flame-retardant agent. Some non-limiting examples of the (F) flame-retardant agent include halogenated flame retardants, phosphorous-based flame retardants, inorganic flame retardants, nitrogen-based flame retardants, and intumescent flame retardants. Halogenated flame retardants include polybrominated diphenyl ethers (PBDEs), tris(1,3-dichloro-2-propyl) phosphate (TCPP), tetrabromobisphenol A (TBBPA), hexabromocyclododecane (HBCD), decabromodiphenyl ether (DecaBDE), pentabromodiphenyl ether (PentaBDE), octabromodiphenyl ether (OctaBDE), hexabromobenzene (HBB), and brominated polystyrene (BPS). The composition further comprises (G) solvents including ethanol, methanol, tetrahydrofuran, and isopropyl alcohol.

A method for preparing a low-carbon, recyclable, plant-sourced insulation foam (“the method”) is also provided. The method includes the step of combining an acrylate functionalized plant-sourced organic resin (A) and a chemical/physical blowing agent (C)/(D) along with a certain percentage (0.1-8% wt.) of surfactant, flame-retardant agent, and solvent to give a biobased acrylate functionalized precursor. The biobased acrylate functionalized precursor is stirred. The biobased acrylate precursor and (B) an amino-functionalized crosslinker are combined to give an uncured foam insulation composition. The uncured foam insulation composition is allowed to cure to give the plant-sourced insulation foam.

The (A) acrylate-functionalized plant-sourced organic resin may comprise acrylated building blocks including acrylated epoxidized vegetable oil, acrylated gallic acid, vanillin diacrylate, cardanol acrylate, pentaerytrioltetraacrylate, and eugenol diacrylate. The step of combining the (A) acrylate functionalized plant-sourced organic resin and the (C) chemical blowing agent to give the biobased acrylate functionalized precursor may further include combining components (A) and (C) with (D) a physical blowing agent, (E) a surfactant, (F) a flame-retardant agent, and/or (G) solvents. In some embodiments, the (C) chemical blowing agent and/or (D) physical blowing agent may be present in the biobased acrylate functionalized precursor in a weight loading of between 1 to 30 wt. %, alternatively between 8 to 20 wt. %. The step of stirring the biobased acrylate functionalized precursor may be performed for between 1 and 30 minutes, alternatively between 1 and 5 minutes, and alternatively between 1 and 3 minutes.

The amount of (A) acrylate-functionalized plant-sourced organic resin and the amount of (B) amino-functionalized crosslinker used may be selected such that the components are present in a molar ratio of between 5:1 to 1:5, alternatively between 3:1 to 1:3, alternatively about 2:1, alternatively 1.75:1, 1.5:1. The step of combining the biobased acrylate precursor and the (B) amino-functionalized crosslinker to give the uncured foam insulation composition may further include the subset of stirring the uncured foam insulation composition. The uncured foam insulation composition may be stirred for 10 to 60 seconds, alternatively 15 to 30 seconds.

Without seeking to be bound by any theory, it is believed the uncured foam insulation composition cures via an aza-Michael reaction between a nucleophile and an unsaturated bound. The (B) amino-functionalized crosslinker operates as a Michael donor, and a double bond from the (A) acrylate-functionalized plant-sourced organic resin acts as the Michael acceptor. In some embodiments, the step of allowing the uncured foam insulation composition to cure occurs under ambient conditions for between 1 and 6 hours. Foam generation may occur before, during, or after the step of allowing the uncured foam insulation composition to cure. Foam generation may occur within 1 to 20 minutes, alternatively within 5 to 10 minutes. The method may further comprise a post-curing heating step. The post-curing heating step generally includes heating the plant-sourced insulation foam to a temperature of between 30 and 50° C., alternatively about 40° C. The temperature is maintained for a period of 1 to 3 hours, alternatively about 2 hours. The post-curing step is performed to facilitate crosslinking between acrylate and amine functional groups and the formation of a crosslinked polymer network within the plant-sourced insulation foam.

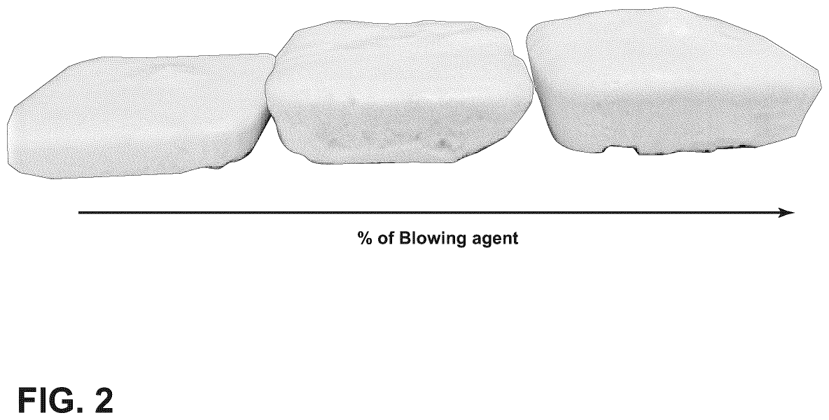

Referring now to FIG. 2, three compositions containing increasing amounts of polymethylhydrosiloxane (PMHS) from left to right are depicted. The composition on the left comprises PMHS in a 2 wt. % loading, the central composition comprises PMHS in a 4 wt. % loading, and the composition on the right comprises PMHS in an 8 wt. % loading. As seen in FIG. 2, higher weight loadings of blowing agent (C) increase the volume of the foam composition. Without wishing to be bound by any theory, it is believed that PMHS increases the foam expansion within the composition, which leads to a higher amount of pores in compositions comprising higher weight loadings of the blowing agent (C). All of the compositions had cell structures with little interconnection between pores and can be described as being “closed-cell foams.” As a result of the correlation between cell size and higher blowing agent (C) loadings, compositions with higher weight loadings of blowing agent (C) are also less dense. For example, in FIG. 2, the left composition has a density of 0.43 g/cm³ while the right composition has a density of 0.19 g/cm³.

Density was measured using gravimetrical analysis. Foam samples were cut into cubical shapes and weighed. The mass of the samples was recorded and the volume was calculated by measuring the dimensions of foam samples using a micrometer.

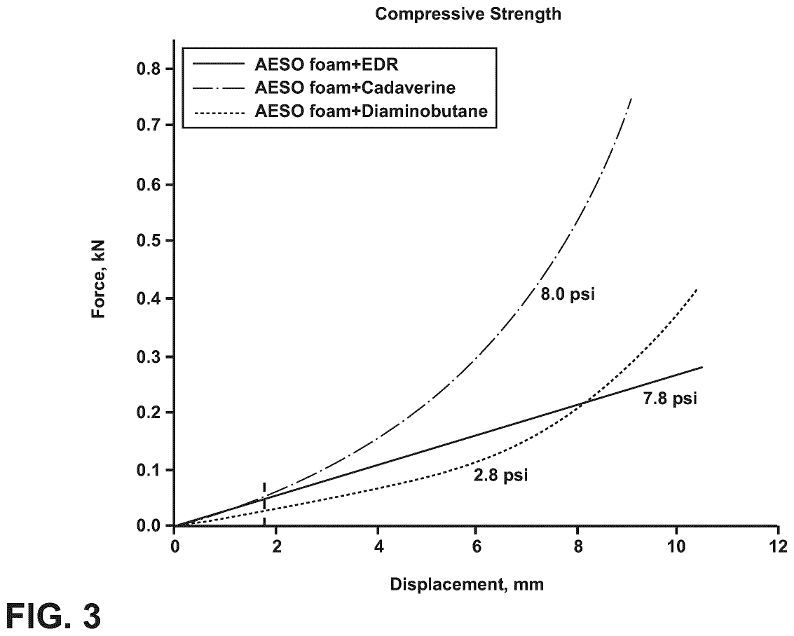

Referring now to FIG. 3, the force (kN) is plotted as a function of displacement (mm) for several compositions comprising different amino functional crosslinkers (B). The compressive performance of the several compositions was characterized according to standard testing following ASTM 1621. The composition comprising diaminobutane crosslinking agent resulted in a soft foam structure with a compressive strength of 2.8 psi. The composition comprising cadaverine crosslinking agent resulted in a more rigid polymer network with a compressive strength of 8 psi. Similarly, the composition comprising polyether diamine includes a more rigid polymer network, with a compressive strength of 7.8 psi. Without wishing to be bound by any theory, it is believed that the diaminobutane foam is softer and less rigid because diaminobutane is a shorter molecule and this leads to a lower crosslink density of polymer foams.

The compression behavior of the biobased foam samples were evaluated at room temperature using an Instron machine with 1 kN cell capacity according to ASTM 1621. The samples were round shaped with 1 inch of thickness. The deformation applied to the samples was 13% of its original thickness. The compressive strength was calculated by dividing the force recorded at 13% compression by the tested area. The crosslinker is not limited to those crosslinkers depicted in FIG. 3, and alternative crosslinkers may be used. The embodiments depicted in FIG. 3 are purely exemplerary, and do not limit the scope of the claimed invention.

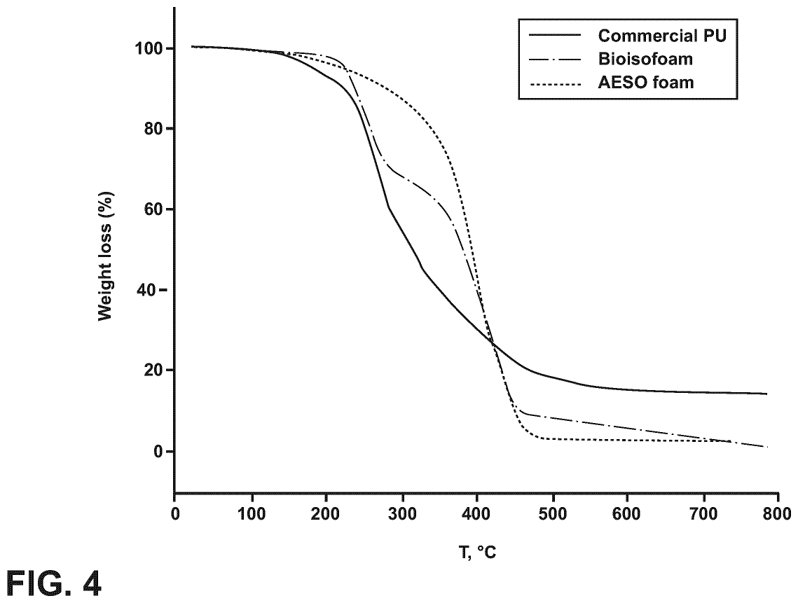

Referring now to FIG. 4, the weight loss (%) is plotted as a function of temperature for the composition and two comparative insulation foams. One comparative insulation foam is a commercial Polyiso foam, while the other comparative insulation foam is a polyurethane foam manufactured using a biobased polyol (“bioisofoam”). The decomposition temperature of the composition is substantially higher than the commercial Polyiso foam, and the composition demonstrates superior temperature stability to the polyurethane foam manufactured using a biobased polyol at higher temperatures (i.e., between ˜300-400° C.). Notably, the composition demonstrates 5% weight loss at 219° C., while the commercial polyiso demonstrates 5% weight loss at the much lower temperature of 178° C. Likewise, the composition demonstrates 50% weight loss at 394° C., while the bioisofoam and commercial polyiso demonstrate 50% weight loss at 381° C. and 312° C., respectively. Therefore, the composition demonstrates superior thermal stability when compared to other foams.

The thermal properties of the developed biobased foams were evaluated using thermogravimetric analysis (TGA) using a TGA55 apparatus (TA Instruments, USA). Around 5 mg of foam sample was placed in a hermetic aluminum pan and heated from 20 to 800° C. at a heating rate of 10° C./min under a nitrogen atmosphere (60 mL/min).

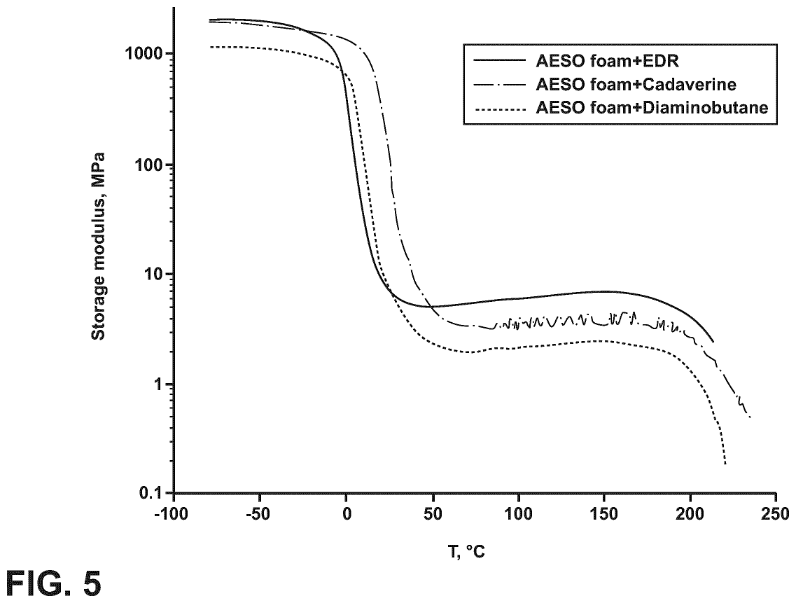

Referring now to FIG. 5, the storage modulus (MPa) is plotted as a function of temperature for several embodiments comprising different amino-functionalized crosslinkers (B). All of the embodiments shown demonstrate a plateau region where the storage modulus is between 1 and 10 MPa for temperatures roughly between 50-180° C. These embodiments demonstrate solid and rubbery mechanical properties in this temperature range. However, at temperatures above about 180° C. all embodiments have a precipitous drop in storage modulus and are substantially flowable, which allows for the reprocessing of the compositions. Notably, all three compositions are easily reprocessable at temperatures between 160-180° C. when under applied pressures for a relatively short period of time (15-30 minutes). The reprocessed compositions do not suffer diminished mechanical performance and have mechanical performance substantially identical to non-reprocessed compositions.

Dynamic mechanical analysis (DMA) was conducted using a DMA 850 (TA Instruments, Inc.) with TRIOS Software. Rectangular film samples (10×12 ×1 mm³) were tested while heating at a rate of 5° C./min from −80 to 250° C. at the frequency of 1 Hz. The alpha transition temperature was determined at the maximum of the tangent delta curve.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. If not otherwise defined herein, “about” is defined as within ±25%, alternatively ±10%, or alternatively ±5%.

1. A low-carbon, recyclable, plant-based foam insulation composition comprising:
(A) an acrylate-functionalized plant-based organic resin;
(B) an amino-functionalized crosslinker; and
(C) a chemical blowing agent.

2. The composition of claim 1, wherein the (A) acrylate-functionalized plant-based organic resin is an acrylate-functionalized vegetable oil.

3. The composition of claim 2, wherein the (A) acrylate-functionalized vegetable oil is an acrylated epoxidized soybean oil (AESO).

4. The composition of claim 1, wherein the (A) acrylate-functionalized plant-based organic resin and the (B) amino-functionalized crosslinker are present in a molar ratio of about 2:1.

5. The composition of claim 1, wherein the (B) amino-functionalized crosslinker is selected from one of: (i) aliphatic amines; (ii) polyether amines; or (iii) aromatic amines.

6. The composition of claim 5, wherein the (B) amino-functionalized crosslinker is polyether diamine.

7. The composition of claim 1, wherein the (B) amino-functionalized crosslinker is a plant-sourced amino-functionalized crosslinker.

8. The composition of claim 1, wherein the (C) chemical blowing agent is polymethylhydrosiloxane.

9. The composition of claim 1, wherein the composition further comprises (D) a physical blowing agent.

10. The composition of claim 9, wherein the chemical blowing agent (C) and/or physical blowing agent (D) are present in the composition in a weight loading of between 1 to 30%.

11. The composition of claim 1, wherein the composition further comprises (E) a surfactant.

12. The composition of claim 1, wherein the composition further comprises (F) a flame retardant agent.

13. The composition of claim 1, wherein the composition further comprises (G) solvent.

14. The composition of claim 1, wherein (i) the acrylate functionalized plant-sourced organic resin (A) has a renewable carbon content of greater than 60 wt. %; (ii) the amino-functionalized crosslinker (B) has a renewable carbon content of greater than 0 wt. %; (iii) the composition has a renewable carbon content of greater than 60 wt. %; or (iv) any combination of (i)-(iii).

15. A method for preparing a low-carbon, recyclable, plant-sourced insulation foam, the method comprising:
combining (A) an acrylate functionalized plant-sourced organic resin, and (C) a chemical blowing agent to give a biobased acrylate functionalized precursor;
combining the biobased acrylate precursor and (B) an amino-functionalized crosslinker to give an uncured foam insulation composition; and
allowing the uncured foam insulation composition to cure to give the plant-sourced insulation foam.

16. The method of claim 15, wherein the step of combining the (A) acrylate-functionalized plant-sourced organic resin and the (C) chemical blowing agent to give the biobased acrylate functionalized precursor further comprises combining the (A) acrylate-functionalized plant- sourced organic resin and the (C) chemical blowing agent with (D) a physical blowing agent, (E) a surfactant, (F) a flame-retardant agent, and/or (G) ethanol.

17. The method of claim 16, wherein the (C) chemical blowing agent and/or (D) physical blowing agent are present in the biobased acrylate-functionalized precursor in a weight loading of between 1 to 30 wt. %.

18. The method of claim 15, wherein the method further comprises the step of stirring the biobased acrylate functionalized precursor for between 1 and 5 minutes.

19. The method of claim 15, wherein the step of allowing the uncured foam insulation composition to cure to give the plant-sourced insulation foam further comprises foam generation that occurs within 1 to 20 minutes.

20. The method of claim 15, wherein the method further comprises the step of heating the plant-sourced insulation foam to a temperature of between 30 and 50° C.
